(19) United States
(12) Patent Application Publication
(10) Pub. No.: US 2010/0316035 A1
(43) Pub. Date: Dec. 16, 2010

(54) POSITION INFORMATION MANAGEMENT DEVICE, NETWORK EDGE DEVICE, AND MOBILE TERMINAL

(75) Inventors: Jun Hirano, Kanagawa (JP); Chan Wah Ng, Singapore (SG); Tien Ming Benjamin Koh, Singapore (SG); Chun Keong Benjamin Lim, Singapore (SG); Pek Yew Tan, Singapore (SG); Mohana Dhamayanthi Jeyatharan, Singapore (SG)

Correspondence Address: Dickinson Wright PLLC;James E. Ledbetter, Esq., International Square, 1875 Eye Street, N.W., Suite 1200, Washington, DC, 20006, US

(73) Assignee: PANASONIC CORPORATION, Osaka (JP)

(21) Appl. No.: 12/867,026

(22) PCT Filed: Feb. 6, 2009
(86) PCT No.: PCT/JP2009/000475

§ 371 Date: Aug. 10, 2010

(30) Foreign Application Priority Data
Feb. 12, 2008 (JP) 2008-030692

(51) Int. Cl. H04W 4/00

(52) U.S. Cl. 370/338

(57) ABSTRACT

Disclosed is a technique that, in a network-based local mobility management method, reduces the load of a network node for managing position information of a mobile terminal and achieves a high scalability with respect to the number of mobile terminals. According to the technique, a LMA (Local Mobility Anchor) (1000) assigns a primary network prefix to each of MAGs (Mobility Access Gateways) (1010, 1020) under the control of the LMA and registers, in a routing table, the correspondence relationship between the position information of each of the MAGs and the primary network prefix assigned to each of the MAGs. In addition, among MNs (MobileNodes) (1030, 1040) connected under the MAGs, for a MN that uses an address including a secondary network prefix, the LMA registers, in a binding cache, the correspondence relationship between the MN and the position information of an MAG to which the MN is connected.

### TECHNICAL FIELD

The present invention relates to a communication technique in a packet switched data communication network. More particularly, the present invention relates to a local mobility management technique to perform mobility management of a mobile terminal on a network side.

### BACKGROUND ART

According to mobile IPv6 (Mobile Internet Protocol version 6), a mobile node (MN) can keep an invariant IP address even when a connection point with the Internet is changed.

This invariant IP address in mobile IPv6 is an address in a home network domain of the mobile node, called a home address (HoA).

On the other hand, while a mobile node connects with a foreign network domain, the mobile node can configure an IP address to be used based on a sub-network prefix (network prefix) advertised from the foreign network domain. The thus configured IP address is called a care-of address, which also brings the reachability to the mobile node.

In order to maintain the reachability of a mobile node irrespective of its position (its location), the mobile node associates the care-of address with the home address and registers the same in a home agent.

In mobile IPv6, the home agent is a router in the home network domain of the mobile node, in which the care-of address of the mobile node is registered. This is achieved by the mobile node that transmits a binding update (BU) message to the home agent.

When the mobile node is away from the home network domain, the home agent intercepts a packet addressed to the home address of the mobile node, and tunnels the packet to the mobile node via the associated care-of address. As described above, in mobile IPv6, a terminal (host) performs mobility management. Thus, mobile IPv6 is known as a terminal-based mobility management protocol.

On the other hand, when the mobile node moves to a local mobility domain, there is another format of mobility management method that doesn't need to perform processing concerning signaling related to mobility. Herein, a proxy entity positioned in the local mobility domain performs mobility management for the mobile node. Such a mobility management method is called network-based mobility management. As for a protocol implementing a network-based mobility management method, there is a proxy mobile IP disclosed in the following Non-Patent Document 1, for example.

When a mobile node moves to a local mobility domain, the mobile node presents identification information (identity) during the course of access authentication procedure, thus connecting with a mobile access gateway (MAG). This identification information is typically used to obtain association with a policy profile (obtainable from a local server, for example) of the mobile node. The policy profile contains characteristics of a network-based mobility service that can be provided and other related parameters (e.g., an on-link prefix assigned to the mobile node, a permitted address configuration mode, roaming policy, and other parameters essential when a network-based mobility service is provided).

When access authentication succeeds, the MAG obtains the policy profile of the mobile node from the local server. Thereby, the MAG keeps all information necessary to execute mobility signaling related to the mobile node. Then, the MAG transmits a router advertisement periodically to the mobile node to advertise an on-link prefix assigned thereto.

While the mobile node moves within the local mobility domain, a connection interface of the mobile node always receives the on-link prefix. This is achieved by each MAG that always refers to the local server to obtain a profile of the mobile node.

As for routing within the local mobility domain, an entity called a local mobility anchor (LMA) functions as a topological anchor point regarding each mobile node. The LMA further manages a reachability state for each mobile node. Therefore, the LMA can be said to be similar to a home agent disclosed in mobile IPv6.

In order to function as an anchor point for each mobile node, there is a need for a LMA to be updated regarding the current position of each mobile node. Thus, in PMIP, for example, every time when a mobile node connects with a MAG, the MAG transmits a proxy binding update (PBU) message to the LMA, thus updating the current position of the mobile node. In this PBU message, identification information unique to the mobile node is associated with the care-of address (or identification information) of the MAG. Then, the LMA refers to this binding, thus enabling transmission of a packet to the mobile node via an appropriate MAG.
Non-Patent Document 1: Gundavelli, S. et al., “Proxy Mobile IPv6”, Internet Engineering Task Force Draft: draft-ietf-netlmm-proxymip6-00.txt, April 2007.

In network-based local mobility management, all MAGs basically share the same network prefix, whereby even when a mobile node changes a connection point within the local mobility domain, the mobile node doesn't need to perform signaling processing concerning mobility.

Meanwhile, when a mobile node establishes a connection under the control of a MAG, the MAG transmits a PBU message to a LMA to update position information of the mobile node. Based on the thus updated information by the PBU message, the LMA creates binding and stores the same in a binding cache entry. The LMA basically refers to this binding cache entry only for transfer of a packet to each mobile node.

However, the LMA creates binding in the unit of connections (interfaces units of the mobile node) and stores the same in the binding cache entry, and therefore the binding cache entry that the LMA stores becomes huge, thus leading to a possibility of taking up too much space in storage capacity of the LMA or requiring excessive processing load for reading/writing of the huge binding cache entry.

As illustrated in FIG. 8, for example, assume that four mobile nodes (MN1, MN2, MN3, MN7) connect under the control of MAG1, two mobile nodes (MN4, MN5) connect under the control of MAG2, and two mobile nodes (MN6, MN8) connect under the control of MAG3, and one LMA manages MAG1, MAG2 and MAG3.

In this case, MN1 to MN8 has an address (or a network prefix for each terminal) (HNP.MN1 to HNP.MN8) configured from the same network prefix (home network prefix: HNP), and as illustrated in FIG. 9, binding that associates the address of each mobile node with identification information of the MAG connecting therewith is registered in the binding cache entry of the LMA.

Further, especially when the number of mobile nodes that the LMA manages increases, a scalability problem becomes prominent. For instance, a method based on a concept to establish a connection simply at one position by the existence of a mobile node with a plurality of interfaces or by each user having a plurality of mobile nodes is expected to fail from the aspects of techniques and economy.

That is, in the case where there are a large number of mobile nodes moving within a local mobility domain, the amount of information on current positions of the respective mobile nodes becomes huge, thus causing a problem that the processing load for the MNs by the LMA increases excessively. As a result, facility cost and management cost of a network provider increases (there is a need to increase throughput of the LMA or to increase the number of LMAs installed, for example), thus leading to a possibility of a failure to provide sufficient service to users.

### DISCLOSURE OF THE INVENTION

In view of the above-stated problems, it is an object of the present invention to provide a position information management device, a network edge device and a mobile terminal that reduce the load of a network node managing position information on a mobile terminal and achieve a high scalability with respect to the number of mobile terminals.

In order to fulfill the above-stated object, a position information management device of the present invention manages position information on a mobile terminal connected with a local mobility domain. The position information management device includes: primary network prefix assignment means that assigns, to each network edge device providing a connection point with the local mobility domain to the mobile terminal, a network prefix range to be used as a primary network prefix; routing storage means that associates the network prefix range assigned to the network edge device by the network prefix assignment means with identification information on the network edge device and stores the same in a routing table; and packet addressed to primary address transferring means that refers to the routing table for packet transfer and transfers, to the network edge device, a packet addressed to an address included in the network prefix range assigned to the network edge device.

In addition to the above-stated configuration, the position information management device of the present invention further includes secondary network prefix advertisement means that advertises, to a specific network edge device, a network prefix range assigned to another network edge device other than the specific network edge device to be used as a primary network prefix so that the specific network edge device can use the network prefix range as a secondary network prefix.

In addition to the above-stated configuration, the position information management device of the present invention further includes: advertisement reception means that receives, from the network edge device, an advertisement of an address of a mobile terminal that does not use an address included in the network prefix range assigned to the network edge device to be used as the primary network prefix among mobile terminals connected under control of the network edge device; binding storage means that associates the address of the mobile terminal received by the advertisement reception means with the identification information on the network edge device and registers the same in a binding cache; and packet addressed to secondary address transferring means that, before referring to the routing table for the packet transfer, refers to the binding cache, and when an address of the packet corresponds with the mobile terminal registered in the binding cache, transfers the packet to the network edge device associated with the address of the mobile terminal.

In addition to the above-stated configuration, the position information management device of the present invention further includes advertisement reception means that receives, from the network edge device, an advertisement of an address of a mobile terminal connected under control of the network edge device; binding storage means that refers to the routing table, when the address of the mobile terminal received by the advertisement reception means from the network edge device is not included in the network prefix range assigned to the network edge device, associates the address of the mobile terminal received by the advertisement reception means with the identification information on the network edge device, and registers the same in a binding cache; and packet addresed to secondary address transferring means that, before referring to the routing table for the packet transfer, refers to the binding cache, and when an address of the packet corresponds with the mobile terminal registered in the binding cache, transfers the packet to the network edge device associated with the address of the mobile terminal.

In addition to the above-stated configuration, the position information management device of the present invention further includes primary network prefix reassignment means that, when the number of registration in the binding cache of associations of an address of the mobile terminal and identification information on the network edge device exceeds a predetermined threshold, reassigns a network prefix range to each network edge device to be used as a primary network prefix.

In addition to the above-stated configuration, the position information management device of the present invention further includes inquiry means that makes an inquiry to each network edge device about the number of mobile terminals using the primary network prefix under control of each network edge device; and primary network prefix reassignment means that reassigns a network prefix range to each network edge device to be used as a primary network prefix in accordance with the number of mobile terminals obtained as a result of the inquiry by the inquiry means.

In order to fulfill the above-stated object, a network edge device of the present invention provides a connection point with a local mobility domain to a mobile terminal. The network edge device includes: primary network prefix assignment message reception means that receives a primary network prefix assignment message to assign a network prefix range to be used as a primary network prefix from a position information management device that manages position information on the mobile terminal connected with the local mobility domain; primary network prefix setting means that sets the network prefix range assigned to be used as a primary network prefix from the position information management device as the primary network prefix; secondary network prefix assignment message reception means that receives, from the position information management device, a secondary network prefix assignment message to assign a network prefix range used as a primary network prefix by another network edge device so as to be used as a secondary network prefix; secondary network prefix setting means that sets the network prefix range assigned to be used as the secondary network prefix from the position information management device as the secondary network prefix; and network prefix advertisement means that advertises to a mobile terminal a network prefix range of the primary network prefix so as to make the network prefix range understood as the primary network prefix, and advertises to the mobile terminal a network prefix range of the secondary network prefix so as to make the network prefix range understood as the secondary network prefix.

In addition to the above-stated configuration, the network edge device of the present invention further includes proxy binding update message transmission means that, when an advertisement message is received from the mobile terminal indicating that an address including the secondary network prefix is used as an address of the mobile terminal, confirms that the address of the mobile terminal is within the network prefix range set as the secondary network prefix, and thereafter transmits a proxy binding update message to the position information management device so as to associate the address of the mobile terminal with its own identification information.

In addition to the above-stated configuration, the network edge device of the present invention further includes address change request means that requests the mobile terminal using an address including the secondary network prefix to switch to an address including the primary network prefix.

In order to fulfill the above-stated object, mobile terminal of the present invention connects with a local mobility domain and includes: network prefix advertisement reception means that receives, from a network edge device providing a connection point with the local mobility domain, an advertisement of a network prefix range of a primary network prefix and an advertisement of a network prefix range of a secondary network prefix; network prefix confirmation means that checks whether an address of the mobile terminal is included in the network prefix range of the primary network prefix or is included in the network prefix range of the secondary network prefix; and advertisement message transmission means that, when an address included in the network prefix range of the secondary network prefix is used as the address of the mobile terminal, transmits an advertisement message to the network edge device so as to advertise that the address of the mobile terminal is included in the network prefix range of the secondary network prefix.

In addition to the above-stated configuration, the mobile terminal of the present invention further includes address change request reception means that receives an address change request from the network edge device requesting switching of the address of the mobile terminal from an address including the secondary network prefix to an address including the primary network prefix; and address change decision means that, when receiving the address change request, decides whether the address of the mobile terminal is to be switched or not.

The present invention is configured as described above, thus reducing, in a network-based local mobility management method, the load of a network node that manages position information on a mobile terminal and achieving a high scalability with respect to the number of mobile terminals.

### BRIEF DESCRIPTION OF THE DRAWINGS

FIG. 1 illustrates an exemplary system configuration in Embodiment 1 of the present invention.

FIG. 2 illustrates an exemplary network prefix assignment message transmitted from a LMA to a MAG in Embodiment 1 of the present invention.

FIG. 3 illustrates an exemplary advertisement message transmitted from a MN to a MAG in Embodiment 1 of the present invention.

FIG. 4 illustrates an exemplary response message from a MAG to a LMA in Embodiment 6 of the present invention.

FIG. 5 is a functional block diagram illustrating an exemplary configuration of a LMA in Embodiment 1 of the present invention.

FIG. 6 is a functional block diagram illustrating an exemplary configuration of a MAG in Embodiment 1 of the present invention.

FIG. 7 is a functional block diagram illustrating an exemplary configuration of a MN in Embodiment 1 of the present invention.

FIG. 8 illustrates an exemplary layout of MAGs and MNs.

FIG. 9 illustrates an exemplary binding cache entry of a LMA in the conventional technique.

FIG. 10 illustrates an exemplary binding cache and such a routing table of a LMA in Embodiment 1 of the present invention.

FIG. 11 illustrates an exemplary functional architecture of a mobile node to embody the present invention.

FIG. 12 illustrates an exemplary functional architecture of a mobile access gateway to embody the present invention.

FIG. 13 illustrates an exemplary functional architecture of a local mobility anchor to embody the present invention.

### BEST MODE FOR CARRYING OUT THE INVENTION

The following describes embodiments of the present invention. Note here that although the following describes specific numbers, time, structures, and other parameters so as to enable the understanding of the present invention, it would be obvious for those skilled in the art that the present invention is operable without being limited to those specific settings.

Herein, the term mobile node used in the present specification refers to mobile equipment and a mobile terminal having a wireless communication function capable of carrying out a communication while moving. A LMA and a MAG in embodiments of the present invention have extended functions according to the present invention in addition to LMA and MAG functions in the conventional proxy mobile IP, where the combination of the functions according to conventional proxy mobile IP and the extended functions according to the present invention can solve the problems in conventional techniques.

### Embodiment 1

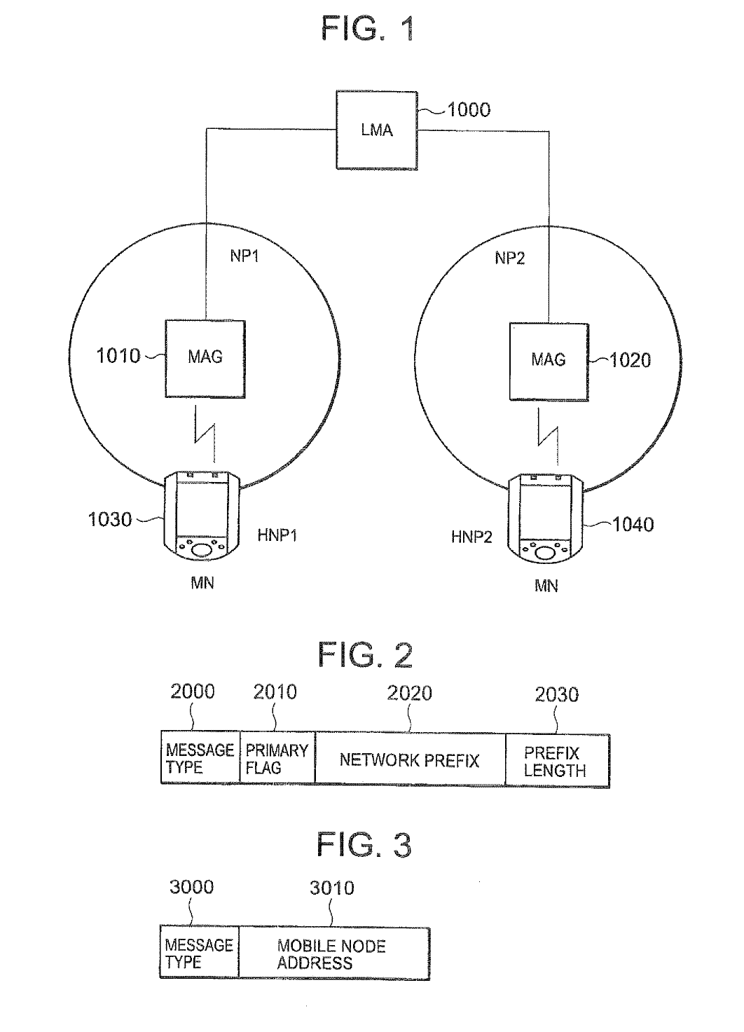

The following describes Embodiment 1 of the present invention. FIG. 1 illustrates an exemplary system configuration in Embodiment 1 of the present invention.

In the configuration of FIG. 1, a LMA (Local Mobility Anchor) 1000 is connected with two MAGs (Mobile Access Gateway) 1010, 1020. Further, a MN (Mobile Node) 1030 has an active connection with the MAG 1010, and similarly a MN 1040 has an active connection with the MAG 1020. Herein, the LMA 1000 is a position information management device that manages position information on a mobile node (mobile terminal) connected with a local mobility domain, and the MAGs are network edge devices that provide a connection point with the local mobility domain to a mobile node.

In the configuration of FIG. 1, assume that the MN 1030 receives a home network prefix that is the value of HNP1 from the MAG 1010, and similarly the MN 1040 receives a home network prefix that is the value of HNP2 from the MAG 1040.

In a normal operation of a proxy mobile IP, the both of the MAGs 1010 and 1020 have to use proxy binding update to update detailed information on the MNs 1030 and 1040 connected therewith, respectively. In an operation of the present invention, however, the LMA 1000 instead assigns a block of a network prefix to each of the MAGs 1010 and 1020, for example.

Herein, consider the case where a NP1 block of a network prefix is provided to the MAG 1010, and a NP2 block of a network prefix is provided to the MAG 1020. In this case, the LMA 1000 creates a network prefix assignment message including information elements as illustrated in FIG. 2, and transmits this message to the MAGs under the control thereof. Herein, it is desirable that the NP1 block assigned to the MAG 1010 and the NP2 block assigned to the MAG 1020 do not have a duplicated network prefix range.

FIG. 2 illustrates an exemplary network prefix assignment message transmitted from a LMA to a MAG in Embodiment 1 of the present invention.

A message type field 2000 allows a MAG as a receiver of this message to identify that this message is a message to assign a network prefix.

A primary flag 2010 set means that the MAG as a receiver of this message has to deal with a network prefix within the following network prefix field 2020 as a network prefix range (primary network prefix range) used for a primary network prefix. On the other hand, in the case of the primary flag 2010 not being set, the MAG as a receiver of this message understands that a network prefix within the following network prefix field 2020 indicates a network prefix range (secondary network prefix range) used for a secondary network prefix. The above-described flag setting is just an example, and as a possible method, for example, a secondary flag may be used instead of the primary flag, and in the case of the secondary flag not being set, a network prefix range to be used as a primary network prefix may be indicated, or each of the primary flag and the secondary flag may be used.

The network prefix field 2020 describes a network prefix that the LMA 1000 assigns to a MAG as a receiver of this message, and a prefix length field 2030 describes a prefix length of the network prefix described in the network prefix field 2020.

Using the above-stated network prefix assignment message, the LMA 1000 assigns the NP1 block as a primary network prefix of the MAG 1010 and assigns the NP2 block as a primary network prefix of the MAG 1020, then stores such assignment, and performs update processing of a routing table so that a packet having a destination address belonging to a subnet of the NP1 block will be transferred to the MAG 1010 and a packet having a destination address belonging to a subnet of the NP2 block will be transferred to the MAG 1020.

Further, the LMA 1000 can assign a network prefix (e.g., NP1 block assigned to the MAG 1010) assigned to a certain MAG as a primary network prefix range to another MAG (e.g., MAG 1020) as a secondary network prefix range.

Note here that one network prefix assignment message includes a plurality of sets of the primary flags 2010, the network prefix fields 2020, and the prefix length fields 2030 inserted.

Further, a network prefix assignment message can be implemented using an already-existing network prefix assignment message. In this case, a primary flag 2010 indicating a primary or a secondary status may be added to an already-existing network prefix assignment message.

In this way, the MAG 1010 can receive a network prefix assignment message with the primary flag 2010 set therein and with a NP1 network prefix range (NP1 block) specified by the network prefix field 2020 and the prefix length field 2030. When receiving such a network prefix assignment message, the MAG 1010 has to deal with the network prefix range of NP1 as a primary network prefix range.

The MAG 1010 may receive a network prefix assignment message (with the primary flag 2010 not set therein) advertising that there is a need to deal with the network prefix range (NP2 block) of NP2 as a secondary network prefix range. In this case, the MAG 1010 has to deal with the network prefix range of NP2 as a secondary network prefix range.

Similarly, when the MAG 1020 receives a network prefix assignment message with the primary flag 2010 set therein and with a NP2 network prefix range (NP2 block) specified by the network prefix field 2020 and the prefix length field 2030, the MAG 1020 has to deal with the network prefix range of NP2 as a primary network prefix range.

When the MAG 1020 receives a network prefix assignment message (with the primary flag 2010 not set therein) advertising that there is a need to deal with the network prefix range (NP1 block) of NP1 as a secondary network prefix range, the MAG 1020 has to deal with the network prefix range of NP1 as a secondary network prefix range.

In the case of assigning, to a mobile node, a network prefix within the primary network prefix range (NP1 block) as a home network prefix (HNP1), the MAG 1010 doesn't need to transmit a proxy binding update message concerning the mobile node. Similarly, in the case of assigning, to a mobile node, a network prefix within the primary network prefix range (NP2 block) as a home network prefix (HNP2), the MAG 1020 doesn't need to transmit a proxy binding update message concerning the mobile node. Note here that this is an example where the LMA 1000 assigns a block of a network prefix to each MAG, and therefore in the case where a network node (AAA (Authentication, Authorization and Accounting) node) other than the LMA 1000 assigns a block of a network prefix to each MAG or in the case where a destination to which each MAG has to transmit a proxy binding update message is a LMA (LMA of a hierarchical configuration, for example) other than the LMA 1000, a proxy binding update message may have to be transmitted.

Herein, the MAG 1010 may transmit, to the LMA 1000, a proxy binding update message concerning all mobile nodes irrespective of a value of a home network prefix assigned to a mobile node. Thereby, there is no need for the MAG to make a decision based on a value of a home network prefix, thus simplifying the configuration and processing of the MAG.

In this case, the LMA 1000 instead checks information included in the received proxy binding update message (to check whether the value of the home network prefix assigned to the mobile node belongs to the primary network prefix range or not).

In the case where a value of a specific home network prefix described in the proxy binding update message belongs to the primary network prefix range assigned to the MAG as a sender of the proxy binding update message, the assignment of the primary network prefix to the MAG as the sender corresponds to the binding concerning this proxy binding update message, and therefore the LMA 1000 can select so as not to record this binding within the binding cache.

After necessary AAA processing is carried out between the MAG 1010 and the MN 1030, the MAG 1010 conducts processing to transmit a RA (Router Advertisement) message to the MN 1030. The RA message allows the MAG 1010 to advertise a primary network prefix and a secondary network prefix, and further to clearly indicate a status of primary or secondary. Herein, such a message advertising the primary network prefix, the secondary network prefix and the statuses thereof may be implemented by a format of an additional flag or an option placed in the RA message. Further, all network prefixes advertised to the MN 1030 along with the operations of the proxy mobile IP may be those used by the MN 1030 only.

In the case where a network requests a stateful address configuration, the MN 1030 conducts a query to a DHCP (Dynamic Host Control Protocol) server to receive an IP address. At this time, the DHCP server has to distribute, to the MN 1030, an address (or a network prefix) within the primary network prefix assigned to the MAG 1010.

This address distribution may be of an already-existing policy format or may be conducted by information exchange between the MAG 1010 and the DHCP server. For instance, the MAG 1010 may advertise, to the DHCP server, so as to provide an address within the range of NP1 in response to a request from a node (e.g., the MN 1030) managed by the MAG 1010. The MAG 1010 may be equipped with a function of the DHCP server.

When receiving the assigned address (including HNP1), the MN 1030 checks whether the network prefix of the address is within the range of the primary network prefix described in the RA message from the MAG 1010. In the case where the network prefix of this address is within the range of the primary network prefix described in the RA message from the MAG 1010, a further operation is not necessary.

On the other hand, the network prefix of this address is within the range of the secondary network prefix, the MN 1030 has to advertise this status to the MAG 1010 with an advertisement message. Herein, this advertisement message is used to advertise to the MAG 1010 that the address of the MN 1030 belongs to the secondary network prefix. For instance, a format illustrated in FIG. 3 may be used for the advertisement message as the simplest format.

FIG. 3 illustrates an exemplary advertisement message transmitted from a MN to a MAG in Embodiment 1 of the present invention.

The advertisement message illustrated in FIG. 3 includes: a message type field 3000 indicating that this message is an advertisement message; and a mobile node address field 3010 including an assigned address (including HNP1).

The advertisement message including the assigned address or HNP1 of the MN 1030 may be piggybacked on any communication message from the MN 1030 to the MAG 1010, or may be replaced therewith.

When receiving the advertisement message from the MN 1030, the MAG 1010 checks the mobile node address field 3010 so as to detect that the value is within the range of the secondary network prefix. Then, in this case, the MAG 1010 has to conduct a normal proxy mobile IP operation and transmit proxy binding update to the LMA 1000.

As another embodiment of the present invention, the DHCP server may advertise the assigned address for the MN 1030 directly to the MAG 1010. In this case, the MAG 1010 can conduct processing promptly without waiting for an advertisement from the MN 1010. This can be realized especially when the MAG 1010 itself is equipped with a function of the DHCP server.

In still another embodiment, when the MN 1030 moves to a network managed by the MAG 1020, the MN 1030 may detect that the assigned address belongs to the secondary network prefix range.

At this time, the MN 1030 can continue to use the currently used address (address including HNP1 used in the network before moving), and in the case where a decision is made to continue to use the current address, the MN 1030 has to conduct processing to transmit an advertisement to the MAG 1020 advertising that the address of the MN 1030 belongs to the secondary network prefix.

At this time, the MN 1030 may conduct a DHCP operation again in the network as a destination managed by the MAG 1020, thus selecting to obtain a new address belonging to the primary network prefix range.

The following describes functions of a LMA in Embodiment 1 of the present invention. FIG. 5 illustrates a configuration of a LMA in Embodiment 1 of the present invention.

The LMA illustrated in FIG. 5 includes: a network prefix assignment advertisement part 5001; a routing storage part 5002; a binding storage part 5003; a packet transfer part 5004; and a secondary network prefix usage detection part 5005. Herein, FIG. 5 schematically illustrates only an extended function of the present invention, where the LMA illustrated in FIG. 5 is equipped with functions of a LMA in the conventional techniques as well.

The network prefix assignment advertisement part 5001 has functions of assigning a primary network prefix to be used by each MAG under the control thereof and advertising a network prefix range to be used as a primary network prefix to each MAG. The network prefix assignment advertisement part 5001 further has a function of assigning a network prefix range, which is assigned to a certain MAG as a primary network prefix, to another MAG so as to be used as a secondary network prefix.

The routing storage part 5002 has functions of managing a routing table required for packet transmission within especially a local mobility domain and storing, in the routing table, a routing entry indicating a correspondence relationship between a primary network prefix assigned to each MAG and identification information (address or network prefix) of the MAG.

The binding storage part 5003 has a function of registering a binding cache entry in binding cache, the binding cache entry indicating a correspondence relationship between an address of a MN using the secondary network prefix and identification information of a MAG connected with the MN.

The packet transfer part 5004 has functions of deciding a transferring destination of a packet based on the binding cache and the routing table and transferring the packet. Herein, when transferring a packet to a MN connected with a MAG under the control thereof, the packet transfer part 5004 firstly refers to the binding cache to detect a binding cache entry including the address of the MN as the packet transferring destination and transfers the packet to the MAG specified by the binding cache entry. In the case where a binding cache entry including the address of the MN as the packet transferring destination is not detected, the packet transfer part 5004 subsequently refers to the routing table and transfers the packet to a MAG corresponding to the network prefix of the address of the MN as the packet transferring destination.

The secondary network prefix usage detection part 5005 has a function of detecting the existence of a MN using the secondary network prefix and a MAG connected with such a MN. For instance, as described above, a MAG receives an advertisement message indicating the usage of the secondary network prefix from a MN and conducts proxy binding update for such a MN to the LMA, whereby the secondary network prefix usage detection part 5005 can detect the existence of a MN using the secondary network prefix and a MAG connected with such a MN.

The following describes functions of a MAG in Embodiment 1 of the present invention. FIG. 6 illustrates a configuration of a MAG in Embodiment 1 of the present invention.

The MAG illustrated in FIG. 6 includes: a network prefix assignment message processing part 6001; a network prefix setting part 6002; a network prefix advertisement part 6003; and a secondary network prefix usage advertisement part 6004. Herein, FIG. 6 schematically illustrates only an extended function of the present invention, where the MAG illustrated in FIG. 6 is equipped with functions of a MAG in the conventional techniques as well.

The network prefix assignment message processing part 6001 has a function of receiving, from a LMA managing position information in a local network domain, a network prefix assignment message including a network prefix range to be used as a primary network prefix or a secondary network prefix.

The network prefix setting part 6002 has a function of, in accordance with the above-stated network prefix assignment message, setting and managing a network prefix range used as the primary network prefix or a network prefix range used as the secondary network prefix.

The network prefix advertisement part 6003 has a function of advertising, to a MN connected with this MAG, network prefix ranges of the primary network prefix and the secondary network prefix using a RA message, for example.

The secondary network prefix usage advertisement part 6004 has a function of, in the case where a MN that uses the secondary network prefix exists among MNs connected with this MAG, advertising the existence of the MN to the LMA. For instance, as stated above, the existence of the MN using the secondary network prefix can be detected by receiving the advertisement message advertising the usage of the secondary network prefix from the MN, and the existence of such a MN can be informed the LMA by conducting proxy binding update for the MN with respect to the LMA.

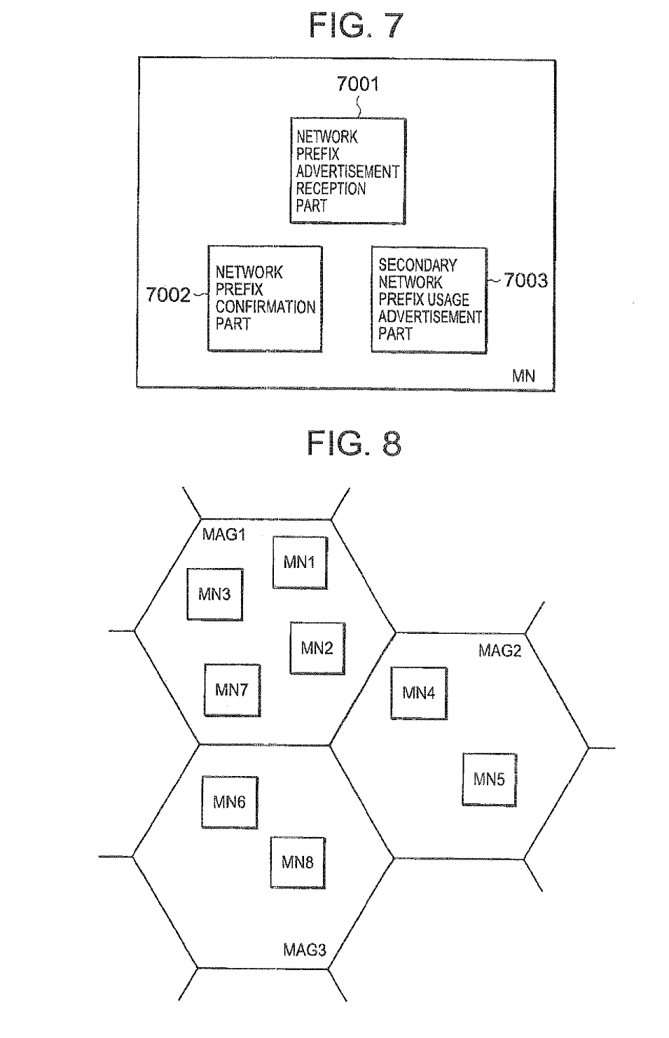

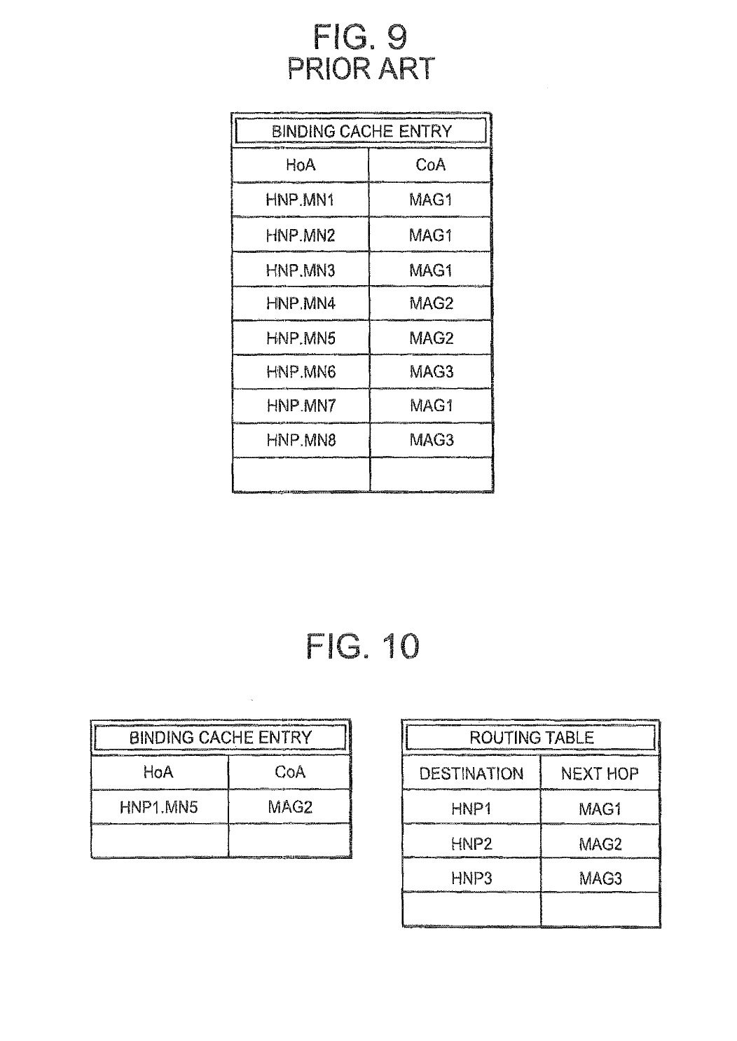

The following describes functions of a MN in Embodiment 1 of the present invention. FIG. 7 illustrates a configuration of a MN in Embodiment 1 of the present invention.

The MN illustrated in FIG. 7 includes: a network prefix advertisement reception part 7001, a network prefix confirmation part 7002; and a secondary network prefix usage advertisement part 7003. Herein, FIG. 7 schematically illustrates only an extended function of the present invention, where the MN illustrated in FIG. 7 is equipped with functions of a MN in the conventional techniques as well.

The network prefix advertisement reception part 7001 has a function of understanding, based on a RA message or the like transmitted from a MAG connected with a MN, for example, a network prefix range of the primary network prefix and a network prefix range of the secondary network prefix that this MAG manages.

The network prefix confirmation part 7002 has a function of checking whether the current address of the MN is included in the network prefix range of the primary network prefix or is included in the network prefix range of the secondary network prefix.

The secondary network prefix usage advertisement part 7003 has a function of, in the case where an address included in the network prefix range of the secondary network prefix is used as the address of the MN, creating an advertisement message to advertise such to a MAG for transmission.

The following describes a status of a binding cache and a routing table of the LMA in Embodiment 1 of the present invention where MAGs and MNs are placed as illustrated in FIG. 8.

At this time, as illustrated in FIG. 10, the routing table stores routing entries associating values (HNP1, HNP2, HNP3) of primary network prefixes assigned to the respective MAGs (MAG1, MAG2, MAG3) and addresses (MAG1, MAG2, MAG3) of transferring destinations (next hop) of packets to which addresses including these primary network prefixes are set as destinations. If all MNs connected under the control of each MAG use an address including the primary network prefix set for each MAG, packets to all MNs can be transferred correctly with settings of this routing table only.

Further, the present invention permits a state where a MN using an address (e.g., address including the secondary network prefix) that does not include the primary network prefix is connected under the control of each MAG. Such a state may occur when a MN moves between MAGs, for example.

For instance, assume that MN5 firstly connects with MAG1 and makes a communication via MAG1 using an address (HNP1.MN5) including the primary network prefix (HNP1) of MAG1. Herein, assume that MN5 moves away from a communication area of MAG1 to a communication area of MAG2 and changes connections from MAG1 to MAG2. At this time, MN5 can newly reconfigure an address including the primary network prefix (HNP2) of MAG2. However, MN5 may continue to use the address (HNP1.MN5) at the time of the connection with MAG1 for a reason of continuing the communication session, for example. In MAG2 where network prefix HNP1 is a secondary network prefix, MN5 advertises the usage of an address (HNP1.MN5) including the secondary network prefix to MAG2 using an advertisement message, and MAG2 advertises the address (HNP1.MN5) of MN5 to the LMA using a proxy binding update message. As a result, as illustrated in FIG. 10, the binding cache registers a binding cache entry indicating a correspondence relationship between the address (HNP1.MN5) of MN5 and identification information (address or network prefix of MAG2) of MAG2.

Note here that Embodiment 1 of the present invention is operable even in the case where a MN with functions of the present invention and a MN according to the conventional techniques are mixed under the control of a MAG. That is, in the case where MN5 is a conventional MN without functions of the present invention, for example, switching of connections from MAG1 to MAG2 is regarded as connection switching within the same local mobility domain, thus continuing to use the address (HNP1.MN5) before movement. However, in this case also, MAG5 registers binding for the address of MN5 in the LMA using a proxy binding update message, whereby a packet addressed to MN5 can be transferred correctly.

As stated above, in Embodiment 1 of the present invention, an entry of a routing table basically manages a packet transferring destination, and exceptional registration is managed by registration to a binding cache entry. The number of entries in the routing table is within about the number of MAGs that the LMA manages and the number of entries in the binding cache entry also is about the number of MNs registered exceptionally, and therefore the number of entries decreases remarkably as compared with the number of entries (about the number of all MNs connected with MAGs that the LMA manages) in a binding cache entry in the conventional techniques.

### Embodiment 2

The following describes Embodiment 2 of the present invention. Embodiment 2 of the present invention describes the case where a MN 1040 obtains an address in a stateless address configuration.

In Embodiment 2 of the present invention, the MN 1040 does not conduct a DHCP operation, and instead creates an IP address based on information acquired using a RA message received from a MAG 1020.

When connecting with a NetLMM domain for the first time, the MN 1040 uses a primary network prefix advertised by a RA message from the MAG 1020 to conduct processing for automatic configuration of an IP address.

Herein, in the case where the MN 1040 moves away from the MAG 1020 and connects with a MAG 1010, the MN 1040 finds that the current address automatically configured (address including the primary network prefix advertised from the MAG 1020) belongs to a secondary network prefix in the network of the MAG 1010.

At this time, the MN 1040 may select so as to automatically configure a new address using the primary network prefix advertised from the MAG 1010, or may select to continue to use the currently set IP address. Herein, in the latter case of continuing to use the currently set IP address, the MN 1040 conducts processing to transmit the above-stated advertisement message (see FIG. 2) to the MAG 1010. In this case, every time a proxy mobile IP operation has to be conducted later, the MAG 1010 has to transmit a proxy binding update message for the MN 1040 to the LMA 1000.

### Embodiment 3

The following describes Embodiment 3 of the present invention. In Embodiment 3 of the present invention, a MAG may request a mobile node to switch from the usage of a secondary network prefix to the usage of a primary network prefix.

This request can be implemented by a message of any format, e.g., by a format of a specific dedicated message or trigger. In the case of the implementation by trigger, IEEE802.21 event such as Link_Action or MIH_Net_HJO_Commit primitive and a command service can be used, for example.

Further, a mobile node may accept a change request for IP address (the above-stated switching request for network prefix) and change an IP address, or may continue to use the currently used IP address without accepting this request.

### Embodiment 4

The following describes Embodiment 4 of the present invention. Embodiment 4 of the present invention describes the case where a MN 1030 is a client MIP node (CMIP node where a terminal itself implements MIP) also and the MN 1030 itself includes a home agent of MIP.

In Embodiment 4 of the present invention, the MN 1030 uses an IP address obtained from a NetLMM domain as a care-of address (CoA) to be updated to the home agent of the MN 1030.

In this case, the MN 1030 synchronizes timing when update is carried out to the home agent by binding update (e.g., timing for binding update when lifetime of the current binding is about to expire in the home agent) with a change of IP addresses when a secondary network prefix is switched to a primary network prefix, whereby the change of IP addresses may be optimized when switching is carried out from the secondary network prefix to the primary network prefix.

Herein, even in the case of continuing to use an old care-of address configured with the secondary network prefix, the MN 1030 has to transmit CMIP binding update to refresh binding. Thus, the MN 1030 can select to change a CoA at the timing when this binding is refreshed, for example. Thereby, the number of messages to be transmitted and processing can be saved.

Since a MAG instead of the MN 1030 doesn't need to transmit proxy binding update and a LMA 1000 doesn't need to add additional route related to binding of position information on the MN 1030, and therefore the amount of messages and processing load for a local access domain can be reduced.

Herein, in the case where the MN 1030 establishes route optimization with a correspondent node, the method described in Embodiment 4 may be used to optimize binding update in the correspondent node.

### Embodiment 5

The following describes Embodiment 5 of the present invention. Embodiment 5 of the present invention describes the case where when a MN 1030 understands that the MN 1030 does not have an active session with a correspondent node or that there is little or no traffic at all in an ongoing communication session with a correspondent node, the MN 1030 delays a change of a connection point, thus optimizing the change of IP addresses in the switching from a secondary network prefix to a primary network prefix.

According to Embodiment 5 of the present invention, the MN 1030 delays a change of a connection point as stated above, whereby even when a large number of ongoing sessions exist or a large number of packets are being transmitted, delay of a packet and loss thereof can be reduced as compared with the case of changing an IP address.

Herein, in the case where the MN 1030 establishes route optimization with a correspondent node, the method described in Embodiment 5 may be used to delay a change of a connection point so as to select to change a care-of address after the completion of these sessions, whereby the number of transmission of binding update by the MN 1030 can be reduced.

### Embodiment 6

The following describes Embodiment 6 of the present invention. In Embodiment 6 of the present invention, a LMA 1000 can dynamically change the assignment of a primary network prefix among a plurality of MAGs. Thereby, the assignment can be changed so that a primary network prefix can be assigned to a MAG effectively in accordance with to a status of a mobile node (a moving status of a mobile node).

In the dynamic change of assignment of a primary network prefix in Embodiment 6 of the present invention, for instance, in the case where the number of entries in a binding cache of the LMA 1000 exceeds a predetermined threshold, the LMA 1000 may decide to reassign a primary network prefix (first example). Herein, each entry existing in the binding cache of the LMA 1000 indicates that a mobile node uses a secondary network prefix. That is, in the first example in Embodiment 6 of the present invention, in the case where the number of mobile nodes using a secondary network prefix exceeds a predetermined threshold based on the number of entries in the binding cache of the LMA 1000, the primary network prefix is reassigned.

Further, in the dynamic change of assignment of a primary network prefix in Embodiment 6 of the present invention, for instance, the LMA 1000 may make an inquiry to each MAG so as to check the number of mobile nodes using a primary network prefix under the control of each MAG (second example). In this case, for example, it becomes possible to understand the number of mobile nodes using the primary network prefix and the number of mobile nodes using the secondary network prefix (the number of entries in the binding cache related to each MAG), and for instance, when a ratio of these values exceeds a predetermined threshold, the primary network prefix may be reassigned.

Herein, the method of the first example and the method of the second example may be combined for use, where in the first example the number of mobile nodes using the primary network prefix or the secondary network prefix is checked based on the number of entries in the binding cache of the LMA 1000 and in the second example the LMA 1000 makes an inquiry to each MAG about the number of mobile nodes using the primary network prefix or the secondary network prefix. For instance, the LMA 1000 may make an inquiry to a MAG only in the case where the number of entries in the binding cache exceeds a predetermined threshold.

In the second example of Embodiment 6 of the present invention, the LMA 1000 transmits a query message to make an inquiry to a MAG, thus enabling to collect information on mobile nodes and information on distribution of each home network prefix (usage status of a home network prefix).

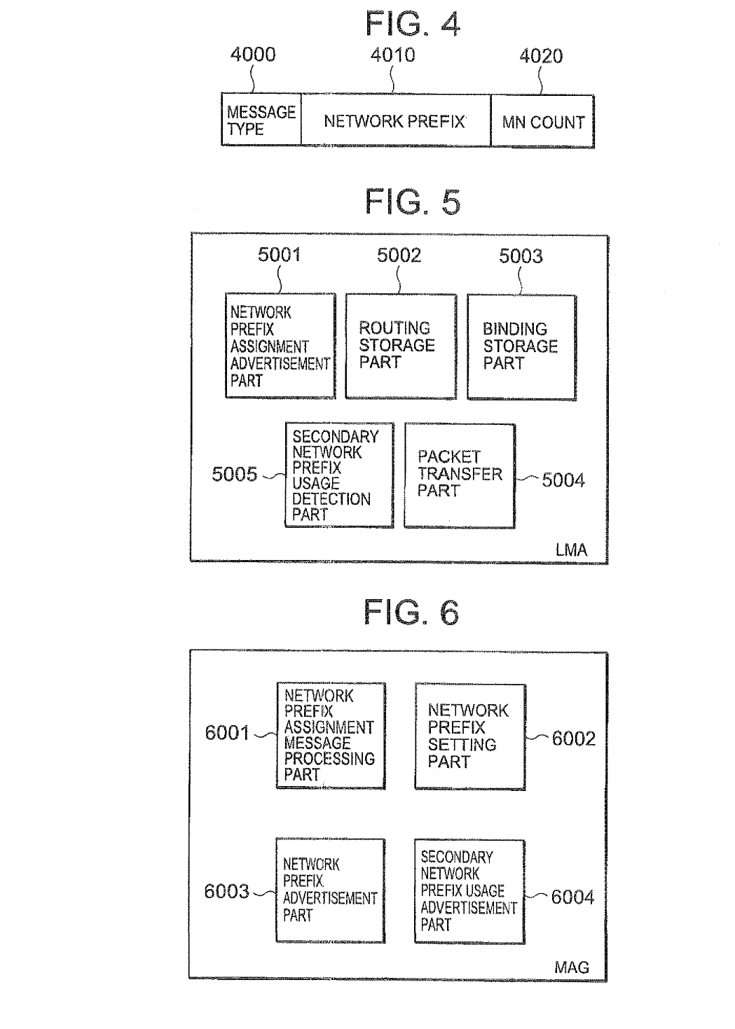

When receiving the inquiry, the MAG makes a response using a message of a format as illustrated in FIG. 4, for example. FIG. 4 illustrates an exemplary response message from a MAG to a LMA in Embodiment 6 of the present invention.

A message type field 4000 enables a MAG as a receiver of this message to identify that this message is a response to a query message by the LMA 1000.

A network prefix field 4010 describes a range of a network prefix that a MAG making a response (a sender of this response message) currently deals with. Although not illustrated, a prefix length field may be provided, in which a value specifying a prefix length of the network prefix is inserted.

A MN count field 4020 includes the number of mobile nodes currently using addresses within a network prefix range specified by the network prefix field 4010 among mobile nodes connected under the control of the MAG making a response.

Herein, a response message may include a plurality of pairs of a network prefix field 4010 and a MN count field 4020 corresponding to each network prefix (primary network prefix and secondary network prefix) that the MAG advertises to those under the control thereof. Further, for instance, the LMA 1000 may designate, in a query message, a network prefix about which the LMA 1000 wants to understand the number of mobile nodes, whereby a MAG may make a response to the LMA 1000 only about the number of mobile nodes concerning the designated network prefix in the response message.

In another embodiment, a system may be implemented with a setting such that each MAG periodically reports information on the number of mobile nodes in each network. In such a system also, the query message illustrated in FIG. 4 can be used to implement a similar function so as to prevent the LMA from spreading a large number of query messages to a network.

Further, the LMA 1000 may integrate a result of all response messages received and then may decide whether reassignment of a primary network prefix for a MAG is to be carried out or not. Such a decision may be conducted in accordance with policy or may be conducted by another algorithm. As one example of the policy, with respect to a MAG with the largest number of mobile nodes using a certain network prefix, such a network prefix may be assigned as a primary network prefix, for example.

Herein, consider the case where the MN 1030 to which a value of HNP1 is assigned as a network prefix moves to the MAG 1020 and the MN 1040 to which a value of HNP2 is assigned as a network prefix moves to the MAG 1010. For instance, assume that it is clarified that, based on exchange of query messages and response messages between the LMA 1000 and each MAG, the density (ratio) of mobile nodes using NP2 block is high under the control of the MAG 1010 and the density (ratio) of mobile nodes using NP1 block is high under the control of the MAG 1020.

At this time, the LMA 1000 may transmit a new network prefix assignment message to the MAG 1010 and the MAG 1020 so that the NP2 block is made a primary network prefix range of the MAG 1010 and the NP1 block is made a primary network prefix range of the MAG 1020.

Herein, a MAG may have a plurality of primary network prefixes or may not have a primary network prefix. That is, the LMA 1000 is not limited especially, and settings of a primary network prefix in each MAG can be changed freely.

After reassignment of the primary network prefix, the LMA 1000 has to release all bindings including entries of care-of addresses indicating related MAGs (MAGs whose settings are changed by reassignment). Further, in the case where mobile nodes using addresses of HNP belonging to a secondary network prefix (secondary network prefix after setting change) exist under the control of a MAG, the MAG has to conduct processing to transmit proxy binding update concerning these mobile nodes to the LMA 1000.

When reassignment of a primary network prefix is carried out, there is a possibility that all MAGs transmit a large number of proxy binding updates at the same time. In order to avoid burst of such signaling traffic, the LMA 1000 may transmit proxy binding update at different timing while spending much time, thus changing the assignment of a primary network prefix. For instance, the LMA 1000 may reassign a first primary network prefix and wait for the reception of proxy binding update occurring as a result, and then may reassign a second primary network prefix.

Herein, a desirable condition for reassignment is the case where the number of mobile nodes that do not use a primary network prefix under the control of a MAG increases as stated above. In this state, many MNs conduct communications using addresses including a secondary network prefix, and as a result the number of entries in the binding cache entry of the LMA 1000 increases.

In the above-stated Embodiment 3 of the present invention, a request is made to a MN to change an IP address so that setting is changed on the MN side. In Embodiment 6 of the present invention, however, a routing table is changed so that a secondary network prefix used more is reset as a primary network prefix, thus making it possible to cope with such a state (decrease the number of entries in the binding cache entry).

### Embodiment 7

The following describes Embodiment 7 of the present invention. Embodiment 7 of the present invention describes the case where a MN 1030 moves to an overlap area where communication areas of some connection points overlap.

The MN 1030 is able to obtain various information on a primary network prefix and a secondary network prefix advertised from each connection point by passive hearing or an information service provided by IEEE802.21, for example.

In the overlap area where communication areas of some connection points overlap, the MN 1030 can connect with any connection point among these. However, based on an IP address currently set in the MN 1030 for example, a connection point may be selected. Further, the MN 1030 may select a connection point advertising the address of the MN 1030 as an address included in the primary network prefix range. Thereby, transmission of an update message can be further decreased, while reducing processing load of the LMA 1000.

### Embodiment 8

The following describes Embodiment 8 of the present invention. Embodiment 8 of the present invention describes the case where a network records a network prefix assigned to each mobile node.

In Embodiment 8 of the present invention, for instance, a MAG 1020 makes an inquiry to a network information service about detailed information on a network prefix currently assigned to the MN 1030. Herein, the information service can be updated by a DHCP server, a MAG with which a mobile node connects, an AAA server or the like. In this configuration, the mobile node simply advertises to the network only when an address or a HNP is changed, and there is no need for advertisement when a connection point is changed. Thereby, transmission processing of the mobile node can be decreased (save electric power and reduce traffic) and the mobile node may come with simpler software and hardware (cost reduction).

### Embodiment 9

The following describes Embodiment 9 of the present invention. In Embodiment 9 of the present invention, a MAG understands a network prefix assigned to a mobile node, thereby enabling a decision as to whether the mobile node uses or not an address within a primary network prefix range assigned to the MAG.

In the case where the mobile node does not use an address within the primary network prefix range assigned to the MAG, the MAG can make an inquiry to the MN so as to decide whether the MN continues to use the original address (currently set address) or switching is conducted to a new address configured from a primary network prefix of the MAG. Then, based on a response result of this inquiry, the MAG can decide whether a proxy binding update message is to be transmitted or not to the LMA. This is especially effective when transmission of an advertisement message by a mobile node is to be delayed.

### Embodiment 10

The following describes Embodiment 10 of the present invention. In Embodiment 10 of the present invention, in the case where a mobile node has a plurality of interfaces, the mobile node may connect with different MAGs existing in the same access domain using the plurality of interfaces. In such a case, the same or different HNPs may be assigned to these different interfaces.

In the case where switching of a home network prefix is conducted on a certain interface (e.g., switching from secondary HNP to primary HNP), a mobile node can use a certain mechanism to synchronize switching on another interface, advertise such switching to an access network via another interface, and assist switching process using another interface (e.g., obtain necessary information via another interface).

### Embodiment 11

The following describes Embodiment 11 of the present invention. In Embodiment 11 of the present invention, in the case where a mobile network service is provided in a local mobility access domain, a function of a MAG can be incorporated into an upper mobile router (MR) of the mobile node.

In this case, the mobile router of the mobile node is treated as a MAG, whereby the above-described present invention can be used. In such a configuration, the MAG (i.e., the MR) advertises a different mobile network prefix to a mobile network node. Herein, similarly to the MAG keeping tunnel with the LMA, the MAG (i.e., the MR) keeps two-way tunnel with its own home agent (HA), which is different only in that the MR has to update to the HA regarding the current position (e.g., care-of address).

Using a mechanism according to the above-described embodiment of the present invention, the HA can reassign a primary mobile network prefix and a secondary mobile network prefix with respect to the MR via this tunnel.

The present invention has been disclosed and described by way of embodiments that can be considered the most practical and preferable. However, it would be obvious for those skilled in the art that the present invention can be modified variously for design and details of the parameters without departing from the scope of the present invention.

For instance, in a proxy mobile IP domain, a mechanism according to the present invention can be used in a hierarchical method. In such a hierarchical domain, a top-level LMA assigns a first level network prefix to another LMA (first level LMA). For instance, the first level LMA subdivides the first level network prefix into a plurality of second level network prefixes, and assigns a second level network prefix to another LMA (second level LMA).

In the case where a mobile node moves to a MAG bringing HNP that is not configured from a network prefix assigned to a LMA in each level and the HNP is assigned to the mobile node (i.e., in the case where a mobile node exists having HNP that does not belong to a first level network prefix), such a LMA needs binding cache entry. That is, the second level LMA herein operates as in a MAG connected with the first level LMA.

In each level, a LMA may dynamically reassign a network prefix to a LMA in the next level, whereby the amount of necessary signaling messages and routing table entries of each LMA can be reduced.

The above description exemplifies the case where the LMA 1000 assigns a block of a network prefix to each MAG. However, a network node (AAA node, for example) other than the LMA 1000 may assign a block of a network prefix to each MAG. In this case, means that assigns a corresponding address or such a network prefix and a node having such a function has to be modified. However, since it is within the category of a normal network design to which node of a network the means/device assigning an address or a network prefix is assigned, or how such a configuration is configured, it is within obvious modification for those skilled in the art to embody the present invention.

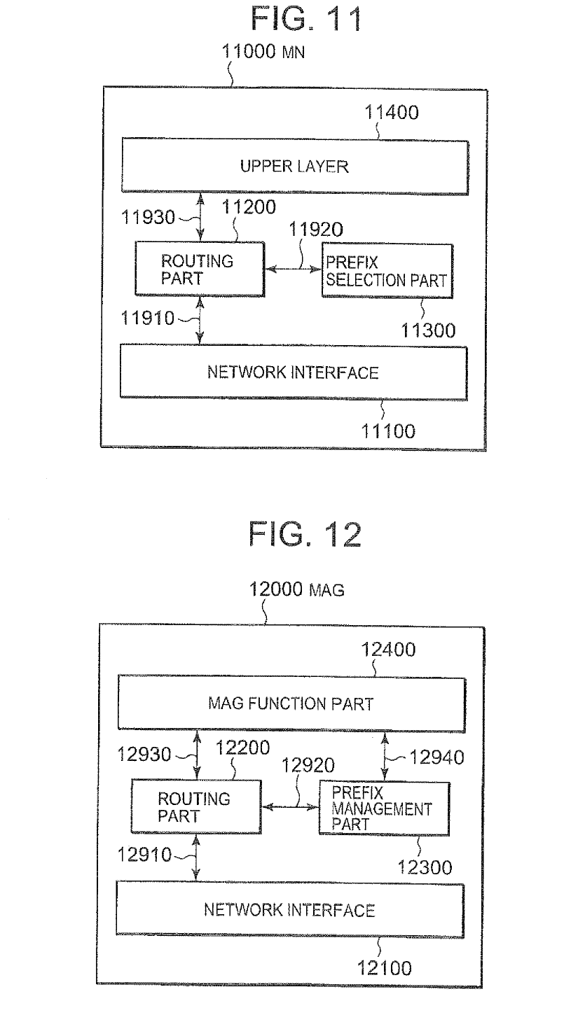

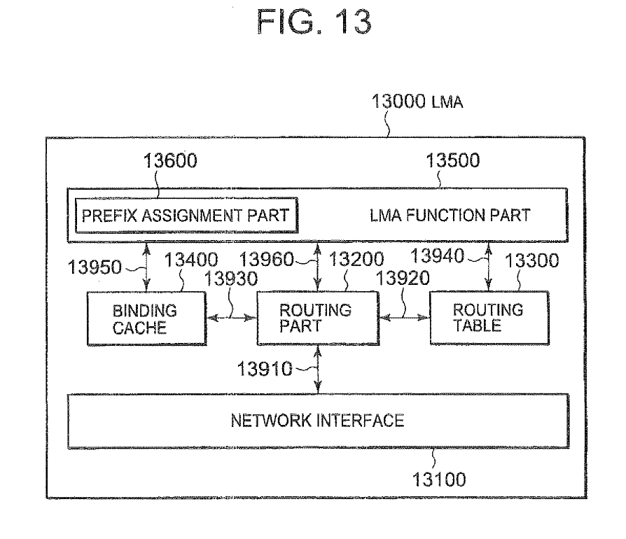

The following describes functional architecture of a mobile node, a mobile access gateway, a local mobility anchor to embody the present invention. Note here that functional architecture of a mobile node (FIG. 11), a mobile access gateway (FIG. 12), and a local mobility anchor (FIG. 13) described below are illustrated in the drawings while considering the configurations of the mobile node illustrated in FIG. 7, the mobile access gateway illustrated in FIG. 6, and the local mobility anchor illustrated in FIG. 5 in view of the functions of each layer.

The mobile node (MN) 11000 illustrated in FIG. 11 includes: a network interface 11100; a routing part 11200; a prefix selection part 11300; and an upper layer 11400.

The network interface 11100 is a functional block including all necessary hardware and software to allow the mobile node 11000 to communicate with another node via any communication medium. Using well-known terms in this technical field, the network interface 11100 represents a communication component of layer 1 (physical layer) and layer 2 (data link layer), firmware, a driver, and a communication protocol. Herein, the mobile node 11000 may include one or more (a plurality of) network interfaces 11100.

The routing part 11200 conducts processing to send a packet to an appropriate program of the upper layer 11400 or an appropriate network interface 11100 (external transmission). Using well-known terms in this technical field, the routing part 11200 represents the implementation of layer 3 (network layer) protocols such as Internet protocol version 4, Internet protocol version 6 and the like.

The routing part 11200 can transmit and receive a packet with respect to an appropriate network interface 11100 via a signal/data path 11910. Similarly, the routing part 11200 can transmit and receive a packet with respect to an appropriate program of the upper layer 11400 via a signal/data path 11930.

The upper layer 11400 represents all protocols and programs existing in upper layers than a network layer in the communication protocol stack. The upper layer 11400 contains transport layer protocols or session layer protocols such as a transport control protocol (TCP: Transmission Control Protocol), a stream control transport protocol (SCTP), and a user datagram protocol (UDP) and programs and software to be communicated with other nodes. Herein, as described above, the upper layer 11400 can conduct packet transferring with the routing part 11200 via the signal path 11930.

The prefix selection part 11300 has a function of controlling the selection of a network prefix used when the mobile node 11000 configures its address. For instance, the prefix selection part 11300 may control so that, when the mobile node 11000 changes a connection point and receives the same network prefix, the mobile node keeps the same address. On the other hand, the prefix selection part 11300 may use, as a decision criterion, whether the currently used address is configured from a primary network prefix of a current access router with which the mobile node 11000 connects, whether an active communication session exists with a correspondent node, and whether a mobile IP function of the routing part 11130 tries to transmit binding update to the home agent thereof. Herein, the prefix selection part 11300 can read out information from the routing part 11200 via the signal/data path 11920 to select a network prefix to be used by the routing part 11200.

The mobile access gateway (MAG) 14000 illustrated in FIG. 12 includes: a network interface 12100; a routing part 12200; a prefix management part 12300; and a MAG function part 12400.

The network interface 12100 is a functional block including all necessary hardware and software to allow the mobile access gateway 12000 to communicate with another node via any communication medium. Using well-known terms in this technical field, the network interface 12100 represents a communication component of layer 1 (physical layer) and layer 2 (data link layer), firmware, a driver, and a communication protocol. Herein, the mobile access gateway 12000 may include one or more (a plurality of) network interfaces 12100.

The routing part 12200 conducts processing to send a packet to an appropriate network interface 12100 (external transmission). Using well-known terms in this technical field, the routing part 12200 represents implementation of layer 3 (network layer) protocols such as Internet protocol version 4, Internet protocol version 6 and the like. The routing part 12200 can transmit and receive a packet with respect to an appropriate network interface 12100 via a signal/data path 12910. Similarly, the routing part 12200 can transmit and receive a packet with respect to the MAG function part 12400 via a signal/data path 12930.

The MAG function part 12400 represents implementation of a function as the mobile access gateway 12000. For instance, the MAG function part 12400 has functions of transmitting proxy binding update instead of a mobile node connected with this mobile access gateway 12000 and storing the current address of the mobile node connected with the mobile access gateway 12000.

In the present invention, in order to enable confirmation as to whether the mobile node uses or not an address configured from the primary network prefix assigned to the mobile access gateway 12000, the MAG function part 12400 further has a function of referring to the prefix management part 12300 via a signal path 12940. In the case where the mobile node uses the address configured from the primary network prefix assigned to the mobile access gateway 12000, the MAG function part 12400 does not create proxy binding update transmitted instead of the mobile node.

The prefix manager 12300 has a function of storing and managing the primary network prefix assigned to the mobile access gateway 12000 and further storing and managing other network prefixes other than the primary network prefix. The prefix manager 12300 further has a function of, in order to explicitly indicate that the network prefix as the primary network prefix is the primary network prefix, changing a router advertisement created by the routing part 12200 via a signal path 12920.

A local mobility anchor (LMA) 13000 illustrated in FIG. 13 includes: a network interface 13100; a routing part 13200; a routing table 13300; a binding cache 13400; and a LMA function part 13500.

The network interface 13100 is a functional block including all necessary hardware and software to allow the local mobility anchor 13000 to communicate with another node via any communication medium. Using well-known terms in this technical field, the network interface 13100 represents a communication component of layer 1 (physical layer) and layer 2 (data link layer), firmware, a driver, and a communication protocol. Herein, the local mobility anchor 13000 may include one or more (a plurality of) network interfaces 13100.

The routing part 13200 conducts processing to send a packet to an appropriate network interface 13100 (external transmission). Using well-known terms in this technical field, the routing part 13200 represents implementation of layer 3 (network layer) protocols such as Internet protocol version 4, Internet protocol version 6 and the like.

The routing part 13200 basically decides a sending route of a packet based on entries in the routing table 13300. An entry in the routing table 13300 indicates an appropriate MAG to which a packet is to be sent in accordance with a network prefix included in a destination address of the packet. Herein, the routing part 13200 can access the entries stored in the routing table 13300 via a signal path 13920.

Herein, in the present invention, before referring to the routing table 13300, the routing part 13200 refers to the binding cache 13400 via a signal path 13930. The binding cache 13400 describes information indicating a MAG to which a packet is to be sent in accordance with a destination address of the packet.

The routing part 13200 can transmit and receive a packet with respect to an appropriate network interface 13100 via a signal/data path 13910. Similarly, the routing part 13200 can transmit and receive a packet with respect to the LMA function part 13500 via a signal/data path 13960.

The LMA function part 13500 represents implementation of a function as the local mobility anchor. For instance, the LMA function part 13500 has functions of receiving and processing proxy binding update and maintaining and managing and the binding cache 13400.

In the present invention, a function of a prefix assignment part 13600 is added to the LMA function part 13500. The prefix assignment part 13600 has functions of deciding the current contents and the size of the binding cache 13400 and deciding whether reassignment of a primary network prefix assigned to a MAG is required or not.

Such a decision on the necessity of the reassignment processing of the primary network prefix is conducted to minimize (or suppressing the signaling amount with proxy binding update between a MAG and a LMA to a minimum) the size of the binding cache 13400. In the case where reassignment of the primary network prefix is to be conducted, the prefix assignment part 13600 transmits an appropriate message (via the routing part 13200) so as to inform the MAG of conducting reassignment of the primary network prefix and then change entries in the routing table 13300.

The LMA function part 13500 can read and write information in the routing table 13300 via a signal path 13940. The LMA function part 13500 can read and write information on entries in the binding cache 13400 via a signal path 13950.

The respective functional blocks used for the above description of embodiments of the present invention can be typically implemented by a Large Scale Integration (LSI) as an integrated circuit. They may be individually made into one chip, or may be made into one chip so as to include a part or the whole thereof. The LSI referred to herein may be called an Integrated Circuit (IC), a system LSI, a super LSI, or an ultra LSI depending on the degree of integration.

The technique for implementing the integrated circuit is not limited to LSI, but may be implemented by a dedicated circuit or a general-purpose processor. Also, a Field Programmable Gate Array (FPGA) enabling programming after the LSI fabrication, or a re-configurable processor that can be reconfigured concerning the connection and configuration of a circuit cell within a LSI may be used.

Moreover, if any technique is developed that can replace the LSI by the development in semiconductor technology or using derivative different techniques, the integration of functional blocks can be naturally performed using such techniques. For instance, biotechnology may be applied thereto.

### INDUSTRIAL APPLICABILITY

The present invention can reduce load on a network node managing position information of a mobile terminal in a network-based local mobility management method, while achieving a high scalability with respect to the number of mobile terminals, and is applicable to communication techniques in a packet switched data communication network and techniques for local mobility management that manages mobility of a mobile terminal on a network side.

1. A position information management device that manages position information on a mobile terminal connected with a local mobility domain, comprising:
primary network prefix assignment means that assigns, to each network edge device providing a connection point with the local mobility domain to the mobile terminal, a network prefix range to be used as a primary network prefix;
routing storage means that associates the network prefix range assigned to the network edge device by the network prefix assignment means with identification information on the network edge device and stores the same in a routing table; and
packet addressed to primary address transferring means that refers to the routing table for packet transfer and transfers, to the network edge device, a packet addressed to an address included in the network prefix range assigned to the network edge device.

2. The position information management device according to claim 1, comprising secondary network prefix advertisement means that advertises, to a specific network edge device, a network prefix range assigned to another network edge device other than the specific network edge device to be used as a primary network prefix so that the specific network edge device can use the network prefix range as a secondary network prefix.

3. The position information management device according to claim 1, comprising:
advertisement reception means that receives, from the network edge device, an advertisement of an address of a mobile terminal that does not use an address included in the network prefix range assigned to the network edge device to be used as the primary network prefix among mobile terminals connected under control of the network edge device;
binding storage means that associates the address of the mobile terminal received by the advertisement reception means with the identification information on the network edge device and registers the same in a binding cache; and
packet addressed to secondary address transferring means that, before referring to the routing table for the packet transfer, refers to the binding cache, and when an address of the packet corresponds with the mobile terminal registered in the binding cache, transfers the packet to the network edge device associated with the address of the mobile terminal.

4. The position information management device according to claim 1, comprising:
advertisement reception means that receives, from the network edge device, an advertisement of an address of a mobile terminal connected under control of the network edge device;
binding storage means that refers to the routing table, when the address of the mobile terminal received by the advertisement reception means from the network edge device is not included in the network prefix range assigned to the network edge device, associates the address of the mobile terminal received by the advertisement reception means with the identification information on the network edge device, and registers the same in a binding cache; and
packet addressed to secondary address transferring means that, before referring to the routing table for the packet transfer, refers to the binding cache, and when an address of the packet corresponds with the mobile terminal registered in the binding cache, transfers the packet to the network edge device associated with the address of the mobile terminal.

5. The position information management device according to claim 1, comprising primary network prefix reassignment means that, when the number of registration in the binding cache of associations of an address of the mobile terminal and identification information on the network edge device exceeds a predetermined threshold, reassigns a network prefix range to each network edge device to be used as a primary network prefix.

6. The position information management device according to claim 1, comprising:
inquiry means that makes an inquiry to each network edge device about the number of mobile terminals using the primary network prefix under control of each network edge device; and
primary network prefix reassignment means that reassigns a network prefix range to each network edge device to be used as a primary network prefix in accordance with the number of mobile terminals obtained as a result of the inquiry by the inquiry means.

7. A network edge device that provides a connection point with a local mobility domain to a mobile terminal, comprising:
primary network prefix assignment message reception means that receives a primary network prefix assignment message to assign a network prefix range to be used as a primary network prefix from a position information management device that manages position information on the mobile terminal connected with the local mobility domain;
primary network prefix setting means that sets the network prefix range assigned to be used as a primary network prefix from the position information management device as the primary network prefix;
secondary network prefix assignment message reception means that receives, from the position information management device, a secondary network prefix assignment message to assign a network prefix range used as a primary network prefix by another network edge device so as to be used as a secondary network prefix;
secondary network prefix setting means that sets the network prefix range assigned to be used as the secondary network prefix from the position information management device as the secondary network prefix; and
network prefix advertisement means that advertises to a mobile terminal a network prefix range of the primary network prefix so as to make the network prefix range understood as the primary network prefix, and advertises to the mobile terminal a network prefix range of the secondary network prefix so as to make the network prefix range understood as the secondary network prefix.

8. The network edge device according to claim 7, comprising proxy binding update message transmission means that, when an advertisement message is received from the mobile terminal indicating that an address including the secondary network prefix is used as an address of the mobile terminal, confirms that the address of the mobile terminal is within the network prefix range set as the secondary network prefix, and thereafter transmits a proxy binding update message to the position information management device so as to associate the address of the mobile terminal with its own identification information.

9. The network edge device according to claim 7, comprising address change request means that requests the mobile terminal using an address including the secondary network prefix to switch to an address including the primary network prefix.

10. A mobile terminal that connects with a local mobility domain, comprising:
network prefix advertisement reception means that receives, from a network edge device providing a connection point with the local mobility domain, an advertisement of a network prefix range of a primary network prefix and an advertisement of a network prefix range of a secondary network prefix;
network prefix confirmation means that checks whether an address of the mobile terminal is included in the network prefix range of the primary network prefix or is included in the network prefix range of the secondary network prefix; and
advertisement message transmission means that, when an address included in the network prefix range of the secondary network prefix is used as the address of the mobile terminal, transmits an advertisement message to the network edge device so as to advertise that the address of the mobile terminal is included in the network prefix range of the secondary network prefix.

11. The mobile terminal according to claim 10, comprising:
address change request reception means that receives an address change request from the network edge device requesting switching of the address of the mobile terminal from an address including the secondary network prefix to an address including the primary network prefix; and
address change decision means that, when receiving the address change request, decides whether the address of the mobile terminal is to be switched or not.
